(19) United States
(12) Patent Application Publication
(10) Pub. No.: US 2026/0274724 A1
(43) Pub. Date: Sep. 17, 2026

(54) VEGETATION-BASED REMEDIATION SYSTEMS, REMEDIATION STRAW AND CARTRIDGE APPARATUSES FOR GROUNDWATER TREATMENT, AND METHODS FOR INSTALLATION OF VEGETATION-BASED REMEDIATION SYSTEMS

(71) Applicant: Applied Natural Sciences, Inc., Wilmington, NC (US)

(72) Inventors: Edward Gatliff, Fairfield Twp., OH (US); Paul Thomas, Cincinnati, OH (US)

(21) Appl. No.: 19/168,012

(22) PCT Filed: Mar. 25, 2024
(86) PCT No.: PCT/US2024/021333

§ 371 Date: Sep. 23, 2025

Related U.S. Application Data
(60) Provisional application No. 63/491,925, filed on Mar. 23, 2023.

(51) Int. Cl. C02F 3/32; C02F 3/04; C02F 103/06

(52) U.S. Cl. CPC C02F 3/327; C02F 3/046; C02F 2103/06; C02F 2203/006

(57) ABSTRACT

Vegetation-based remediation systems, remediation straws, and in-line cartridges for groundwater treatment, and methods for installing vegetation-based remediation systems are disclosed herein. A vegetation-based remediation system can include a liner sleeve for positioning within an excavated hole and a bottom impermeable barrier positioned at a bottom of the excavated hole on which the liner sleeve resides. The vegetation-based remediation system can also include a straw for insertion in a hole through backfill soil mixture, the liner sleeve, and the bottom impermeable barrier and into the soil below the bottom impermeable barrier. The straw has an inlet well screen and an outlet well screen. A removable treatment cartridge can be inserted into the straw. The treatment cartridge can have a filter section with treatment media therein. The filter section can be positioned within the straw between the outlet well screen and the inlet well screen of the straw upon installation.

### RELATED APPLICATION

The present application and presently disclosed subject matter claims the benefit of PCT International Patent Application Serial. No. PCT/US2024/021333, filed Mar. 25, 2024, and U.S. Provisional Patent Application Ser. No. 63/491,925, filed Mar. 23, 2023, to which PCT International Patent Application Serial. No. PCT/US2024/021333 claims priority and benefit. The disclosures of both patent applications referenced above are incorporated herein by reference in their entireties.

### TECHNICAL FIELD

The present subject matter relates to vegetation-based remediation systems, remediation straws, and in-line cartridges for groundwater treatment, and methods for installing vegetation-based remediation systems. For example, straws and groundwater treatment cartridges used in conjunction with vegetation-based remediation systems are provided. In particular, the present subject matter relates to groundwater treatment cartridges used in phytoremediation to facilitate the function of vegetation-based remediation systems that involve borings greater than 12-inches in diameter and greater than 48-inches deep.

### BACKGROUND

The preservation and protection of the environment are among the most paramount social and economic issues affecting our society today. In instances where soil and/or groundwater have been contaminated by industry, the characterization of contamination and the assessment of remediation alternatives should include methods that are effective, sustainable, and protective of human health and the environment.

During the characterization phase, contaminants in soil and/or groundwater are identified. Typical contaminants of soil and groundwater include agricultural chemicals, heavy metals, volatile organic compounds, semi-volatile organic compounds, and other inorganic or organic substances. Once the nature and extent of contamination by any of these or other contaminants is ascertained, the feasibility of various remediation approaches must be assessed, and an appropriate methodology or methodologies selected.

These methodologies can include monitored natural attenuation as well as bioremediation techniques. Both of these methodologies take advantage of natural biological processes. Bioremediation techniques include the use of microbes and/or plants to facilitate the removal of contaminant mass from soil or groundwater. The use of plants is generally referred to as phytoremediation. The natural ability of vegetation to facilitate the removal of contaminant mass from soil and groundwater and to influence the movement of groundwater is of great potential benefit to the environment and society. Its effectiveness, low operating costs, and sustainability can make it preferrable to more traditional mechanical remediation systems.

The concept underlying phytoremediation is to allow vegetation to facilitate the remediation of soil and/or groundwater by direct uptake and in-plant degradation/sequestration; transpiration into the atmosphere; and/or to introduce via the root system nutrients, substrates, water, and oxygen to enhance microbial degradation and other biological remediation processes, thereby reducing contaminant mass in soil and/or groundwater. Plants can also be used to influence the characteristics of groundwater flow thus influencing the potential migration of contaminants. Different contaminants respond to phytoremediation processes in different ways. Some are sequestered in plant tissues while others are degraded by microbial processes in the soil surrounding the plant roots. Some contaminants pass through the plant and are transpired into the air where they are subject to photodegradation.

Phytoremediation has grown beyond simply planting vegetation in contaminated areas. Overall strategies, including a determination of what plant species to employ based on the type of contamination present at the site, the site's geographic location, and other site variables are utilized. Phytoremediation has been limited in its potential to remediate groundwater by depth and by the confounding effect of precipitation. Plants will preferentially consume percolating precipitation over groundwater because this water is more readily available to shallow plant roots. This is true even of plants that are capable of relatively deep rooting. Groundwater is only consumed when the volume of percolating precipitation is not sufficient to support the plant's requirement for water.

A technique that was used in the past when planting the vegetation in a phytoremediation system has been to alternately run an auger into the ground and place a hard pipe, such as PVC piping, into the hole in the ground. The hard pipe was inserted to the point where the unsaturated layer (the vadose zone) meets the saturated layer (the capillary fringe). In employing this technique, the holes were about thirty-six (36) inches in diameter and as deep as twelve (12) feet. The hard pipes used in this technique have been from four (4) to twelve (12) feet long. The object of the hard casing was to encourage root growth in the vertical direction and prevent the more natural horizontal root growth near the surface since there may be less contamination near the surface level. However, the use of hard casings is expensive at remediation sites which include many trees. Perhaps more importantly, surface water migrates vertically along the hard casing to deeper levels. This affects the root growth in that the deeper root system would be less apt to develop to seek water and nutrients at a deeper level in order to meet its needs for growth, and instead would feed on the migrating surface water. Methods have been developed to restrict a plant's access to percolating precipitation, but the methods are limited to depth ranges of 30 to 50 feet depending on subsurface conditions. Complications with the effectiveness of the remediation can occur when the contaminated groundwater to be treated is at deeper depths.

Thus, a need exists for providing access by a phytoremediation system to contaminated groundwater at deeper depths.

### SUMMARY

The present subject matter relates to straws and cartridges for groundwater treatment, groundwater treatment cartridges integrated with vegetation-based remediation systems, and methods for installation of vegetation-based remediation systems. Methods related to the assembly and use of the in-line treatment cartridges herein are also provided.

Thus, it is an object of the presently disclosed subject matter to provide in-line cartridges for groundwater treatment, groundwater treatment cartridges integrated with vegetation-based remediation systems, and methods for installation of vegetation-based remediation systems as well as methods related thereto. While one or more objects of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1 illustrate a schematic partial cross-sectional views of a vegetation-based remediation system according to the present subject matter;

FIGS. 2A and 2B illustrate schematic partial tiered cross-sectional views of other embodiments of vegetation-based remediation systems according to the present subject matter;

FIGS. 3A and 3B illustrate different vertical cross-sectional views of an embodiment of a vegetation-based remediation system that uses an embodiment of a straw and cartridge apparatus to treat contaminated soil and/or groundwater according to the present subject matter;

FIG. 4 illustrates perspective view of an embodiment of a cartridge used in a straw and cartridge according to the present subject matter.

Repeat use of reference characters in the present specification and drawings is intended to represent the seam or analogous features or elements of the present subject matter.

Other documentation and related information may be provided herewith to further illustrate these and other aspects of the subject matter disclosed herein and to further provide disclosure that is enabling to one of ordinary skill in the art.

### DETAILED DESCRIPTION

Reference now will be made to the embodiments of the present subject matter, one or more examples of which are set forth below. Each example is provided by way of an explanation of the present subject matter, not as a limitation. In fact, it will be apparent to those skilled in the art that various modifications and variations can be made in the present subject matter without departing from the scope or spirit of the present subject matter. For instance, features illustrated or described as one embodiment can be used on another embodiment to yield still a further embodiment. It is to be understood by one of ordinary skill in the art that the present discussion is a description of exemplary embodiments only and is not intended as limiting the broader aspects of the present subject matter, which broader aspects are embodied in exemplary constructions.

Although the terms first, second, right, left, front, back, top, bottom, etc., may be used herein to describe various features, elements, components, regions, layers and/or sections, these features, elements, components, regions, layers and/or sections should not be limited by these terms. These terms are only used to distinguish one feature, element, component, region, layer, or section from another feature, element, component, region, layer, or section. Thus, a first feature, element, component, region, layer, or section discussed below could be termed a second feature, element, component, region, layer, or section without departing from the teachings of the disclosure herein.

Similarly, when a feature or element is being described in the present disclosure as “on” or “over” another feature or element, it is to be understood that the features or elements can either be directly contacting each other or have another feature or element between them, unless expressly stated to the contrary. Thus, these terms are simply describing the relative position of the features or elements to each other and do not necessarily mean “on top of” since the relative position above or below depends upon the orientation of the device to the viewer.

Embodiments of the subject matter of the disclosure are described herein with reference to schematic illustrations of embodiments that may be idealized. As such, variations of the shapes and/or positions of features, elements, or components within the illustrations because of, for example but not limited to, user preferences, manufacturing techniques and/or tolerances are expected. Shapes, sizes and/or positions of features, elements or components illustrated in the figures may also be magnified, minimized, exaggerated, shifted, or simplified to facilitate explanation of the subject matter disclosed herein. Thus, the features, elements or components illustrated in the figures are schematic in nature and their shapes and/or positions are not intended to illustrate the precise configuration of the subject matter and are not necessarily intended to limit the scope of the subject matter disclosed herein unless it specifically stated otherwise herein.

As used herein, the term a “plurality” means two or more.

As used herein, the term “vegetation” and the term “plant” are used interchangeably herein.

As used herein, the terms such as “include,” “including,” “contain,” “containing,” “having,” and the like mean “comprising.” The present disclosure also contemplates other embodiments “comprising,” “consisting of,” and “consisting essentially of,” the embodiments or elements presented herein, whether explicitly set forth or not.

As used herein, the term “a,” “an,” “the” and similar terms used in the context of the disclosure (especially in the context of the claims) are to be construed to cover both the singular and plural unless otherwise indicated herein or clearly contradicted by the context. In addition, “a,” “an,” or “the” means “one or more” unless otherwise specified.

As used herein, the term “or” can be conjunctive or disjunctive.

As used herein, the term “substantially” means to a great or significant extent, but not completely.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to +10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “~” means “about” or “approximately.”

As used herein, the term “straw” means an elongated tube used to convey fluid. The cross-sectional shape of the tube can be a variety of different shapes, including, but not limited to circular, square, rectangular, hexagonal, and octagonal cross-sectional shapes. For example, in some embodiments, the tube can comprise a hollow cylinder with an outer diameter and an inner diameter that defines a hollow space, wherein a length of the tube is a greater than the inner diameter.

As used herein, the term “soil mixture” means soil that is used to fill a liner sleeve of a vegetation-based remediation system. In some embodiments, a soil mixture can include soil prepared for filling a liner sleeve of a vegetation-based remediation system. In some embodiments, a soil mixture can include soil tailored to specific requirements for hydraulic and chemical characteristics. In some embodiments, a soil mixture can include soil from an excavated hole in which a liner sleeve of a vegetation-based remediation system. In some embodiments, a soil mixture can include soil pre-prepared for filling a liner sleeve of a vegetation-based remediation system before excavation of a hole in which a liner sleeve of a vegetation-based remediation system is to be installed. In some embodiments, a soil mixture can include additives that are mixed in with soil to form the soil mixture. Such additives can include, but are not limited to, chemical additives and organic matter additives.

All ranges disclosed herein include both end points as discrete values as well as all integers and fractions specified within the range. For example, a range of 0.1-2.0 includes 0.1, 0.2, 0.3, 0.4 . . . 2.0. If the end points are modified by the term “about,” the range specified is expanded by a variation of up to ±10% of any value within the range or within 3 or more standard deviations, including the end points. Thus, it is to be understood that the ranges and limits mentioned herein include all ranges located within the prescribed limits (i.e., subranges). For instance, a range from about 100 to about 200 also includes ranges from 110 to 150, 170 to 190, 153 to 162, and 145.3 to 149.6. Further, a limit of up to about 7 also includes a limit of up to about 5, up to 3, and up to about 4.5, as well as ranges within the limit, such as from about 1 to about 5, and from about 3.2 to about 6.5 as examples.

The present subject matter relates to in-line cartridges for groundwater treatment, groundwater treatment cartridges integrated with vegetation-based remediation systems, and methods for installation of vegetation-based remediation systems. The present subject matter also relates to methods for assembly and use of in-line treatment cartridges and phytoremediation systems using such in-line cartridges.

Methods and systems have been developed by Applied Natural Sciences Inc., headquartered in Wilmington, North Carolina, known as TREEWELL®, to restrict a plant's access to percolating precipitation. Some such methods and systems are outlined in U.S. Pat. Nos. 5,829,191; 5,829,192; 6,189,262; 6,205,708; and 7,272,911, all of which are incorporated herein in their entireties, as examples. The methods and systems can utilize a large diameter boring (typically about 36 inches to about 60 inches or more) that is lined with an open bottom impermeable barrier and backfilled with a soil mixture tailored to specific requirements for hydraulic and chemical characteristics. Such methods and systems also allow the targeting of specific contaminated water-bearing strata that may be overlain by uncontaminated water-bearing strata. In such methods and systems, a plant, typically a tree, is placed in the top of the boring and is forced to consume groundwater from below the lower extent of the open bottom impermeable barrier. The backfill soil has the added benefit of providing remediation treatment to contaminated groundwater through microbial and/or chemical degradation through the addition of organic matter, microbial inoculants, or other treatment media. The plant in such a system functions primarily to move contaminated water through the soil column treatment system however it provides the potential for in-plant degradation, sequestration, or transpiration of contaminant mass.

Such methods and systems can be limited to depths ranging from 30 to 50 feet depending on subsurface conditions. Alternative methods and systems can be used to target groundwater at potentially unlimited depths. Such methods and systems can utilize a large diameter boring (typically about 36 inches to about 60 inches or more) that is lined with an impermeable barrier on the sides and includes a closed bottom impermeable barrier that combines a bentonite clay barrier above and below the base of the closed bottom to seal the bottom. The boring is then backfilled with a soil mixture tailored to specific requirements for hydraulic and chemical characteristics to form a phytoremediation unit. Following completion of soil backfilling, a drill rig is used to install a small diameter well, referred to herein as a straw well inside the phytoremediation unit. In some embodiments, the straw well can be a casing about 2-inch in diameter. This straw well penetrates the closed and sealed bottom of the phytoremediation unit and is completed with a well screen at the desired depth. This depth can potentially be hundreds of feet deep. A secondary well screen can be included in the well casing inside the phytoremediation unit above the closed bottom impermeable barrier. In order for the system to function, it is necessary that the groundwater at the lower screen be under sufficient hydraulic pressure to be forced up the straw well casing and out the upper well screen inside the phytoremediation unit.

This straw well variation on the phytoremediation unit, in addition to providing access to deeper groundwater, provides the opportunity to address two other potential problematic remediation scenarios. One such problematic scenario is groundwater contaminants that, due to either their chemical composition or concentration, are toxic to the plants and/or microbes used in the system. Another problematic scenario is groundwater contamination that is not treatable by the mechanisms present in the system. Both of these scenarios can be addressed by adding a removeable and replaceable “cartridge” to the “straw” casing that contains treatment media such as granular activated carbon or ion specific resins. The removable and replaceable in-line “cartridge” provides the opportunity for passive, sustainable removal of contaminant mass from groundwater using no electrically operated devices. Spent treatment media is removed from the cartridge and new media is added. The “cartridge” also allows the quantification of mass removal rates even in systems where active remediation is possible. An in-line cartridge can be placed for a period of time after which it is removed, and the volume of contaminant mass is measured determining the rate of contaminant mass transfer into the phytoremediation unit.

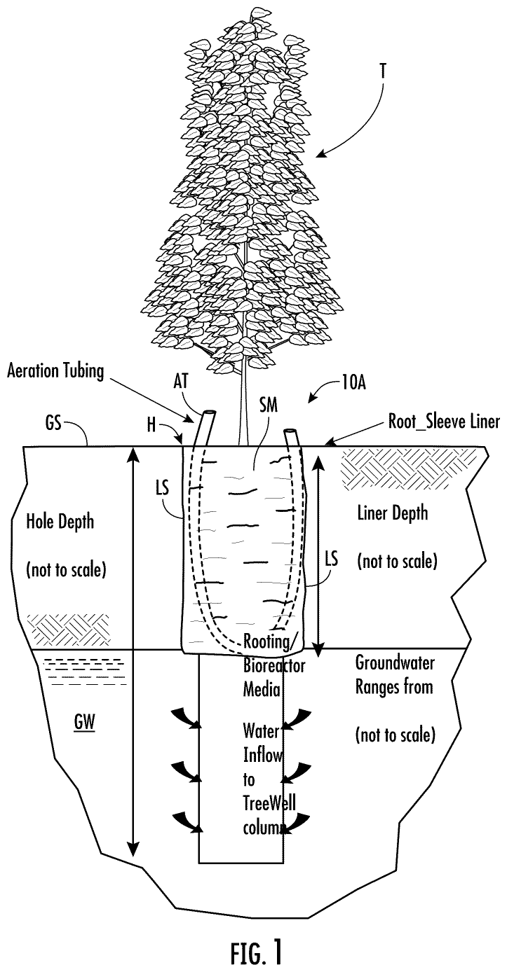

FIG. 1 shows an embodiment of a vegetation-based remediation system, generally designated 10A, can be used to treat contaminated groundwater GW that is relatively close to a ground surface GS. In some embodiments, as shown, the vegetation-based remediation system 10A can comprise a liner sleeve LS for insertion into a hole where the contaminated groundwater GW can be accessed and an aeration tube AT for placement with the liner sleeve LS. The vegetation-based remediation system 10A can also comprise the soil mixture SM and a tree T grown in a first location with an established root system RS and then transplanted in the location with contaminated soil and/or groundwater using systems and methods outlined in U.S. Pat. Nos. 5,829,191; 5,829,192; 6,189,262; 6,205,708; and 7,272,911, all of which are incorporated herein in their entireties. A hole can be excavated in the area containing the contaminated soil or groundwater GW and the liner sleeve LS can be placed in the hole to provide a wall liner within the hole. The aeration tubing AT can be inserted into the hole to provide oxygen to the root system RS of the tree T once the tree T is installed. The tree T is transplanted into the liner sleeve LS within the hole after the liner sleeve LS is backfilled with a soil or soil mixture. The liner sleeve LS can prevent unwanted water in the subsurface from being absorbed by the root system RS of the tree T so that the root system RS obtains its water from the contaminated soil and/or groundwater GW such that the root system RS and the surrounding soil act as a bioreactor to remove and process the contaminants from the soil and/or groundwater GW.

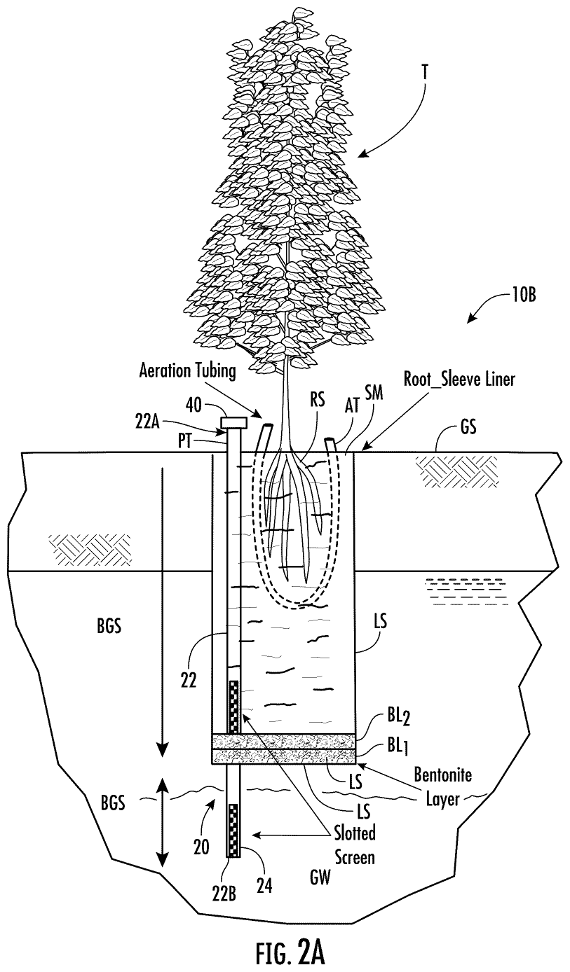

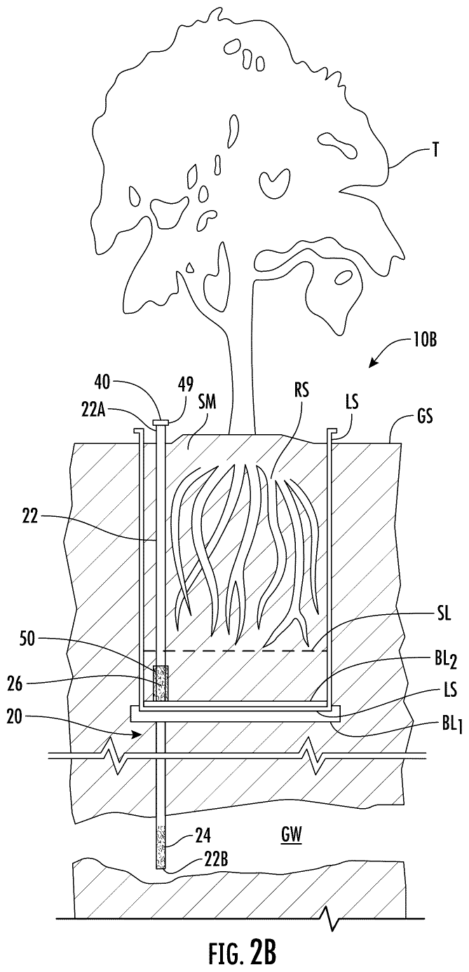

As shown in FIGS. 2A and 2B, for deep groundwater contamination, another embodiment of a vegetation-based remediation system 10B can be used that includes a straw and cartridge apparatus 20 and the liner sleeve LS. The liner sleeve LS can have a closed bottom which rests on an impermeable bottom barrier 12 that can comprise a first bentonite layer BL₁. Additionally, in some embodiments, the impermeable bottom barrier 12 can comprise a second bentonite layer BL₂ can be placed along the bottom of the liner sleeve LS. To allow the deep contaminated groundwater to move upward into the liner sleeve LS, the straw and cartridge apparatus 20 can comprise a straw 22 and a removable treatment cartridge 40 having a treatment media 42 therein for insertion into the straw 22. The straw 22 can be inserted into and through the liner sleeve LS and the impermeable bottom barrier 12 of the bentonite layers BL₁, BL₂ to the desired depth where the groundwater is contaminated. In general, the straw 22 can draw groundwater that is contaminated through the treatment media 42 in the cartridge 40 to filter the groundwater before it passes through the outlet well screen 26 into the soil mixture SM within the liner sleeve LS so that the root system RS of the tree T can consume the groundwater and move the contaminants into parts of the remediation system 10B where they can be transformed, sequestered, or transpired. As shown in FIG. 2A, the straw 22 can feed groundwater from below the liner sleeve LS into the soil mixture SM. The groundwater will reside in the soil mixture SM up to a saturation line SL, or the potentiometric surface. In particular, the confined water-bearing strata in which the end of the straw 22 resides is under sufficient hydraulic pressure which forces the groundwater up the straw 22 such that the groundwater entering the soil mixture SM within the liner sleeve LS saturates the soil up to the potentiometric surface, or saturation line SL. The root system RS of the tree T tends to grow down to the saturation line SL.

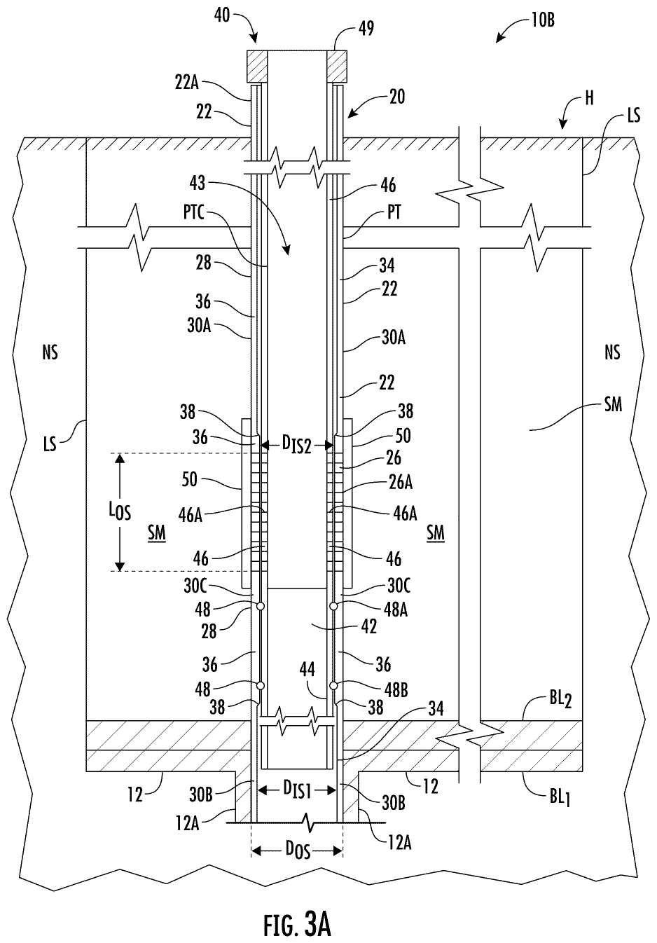

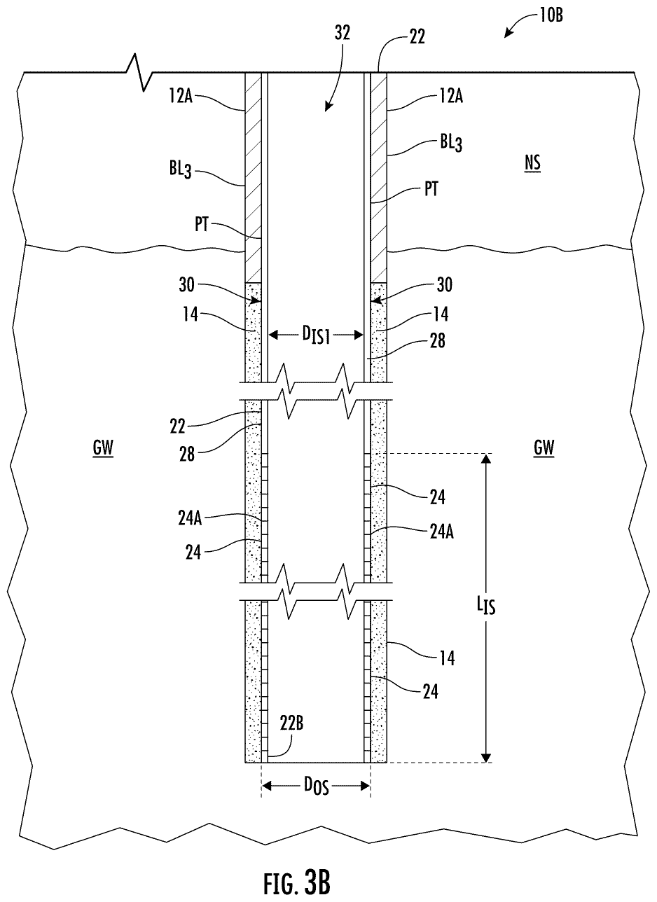

Referring to FIGS. 3A and 3B, the straw 22 can comprise a well casing PT that forms an exterior of the straw and cartridge apparatus 20. The well casing PT of the straw 22 can comprise a first end, or top end, 22A that can extend out from the top surface formed by the backfill soil mixture SM within the liner sleeve LS when the straw 22 is installed in the vegetation-based remediation system 10B and a second, or bottom, end 22B that resides in the area of the contaminated soil and/or groundwater GW when the straw 22 is installed in the vegetation-based remediation system 10B. The straw 22 can comprise a straw wall 28 that forms a straw perimeter diameter D_{OS}. In some embodiments, for example, the straw perimeter diameter D_{OS} can be about 3 inches. For example, the cylindrical well casing PT of the straw 22 can comprise a polyvinyl chloride (PVC) cylinder, such as a PVC pipe, which has a 3 inch outer diameter. The cylindrical well casing PT can form the straw wall 28 and the straw perimeter diameter D_{OS}. The straw 22 can be hollow such that an internal channel 32 can extend through the straw 22 between an interior surface of the straw wall 28. The length of the straw 22 can vary depending on the project in which the plant-remediation system 10B is being used.

Referring to FIGS. 3A and 3B, the straw 22 can comprise a first, or inlet, well screen 24 in a portion of the straw wall 28 that can be positioned in the soil below the bottom impermeable barrier upon installation allows the contaminated groundwater to flow into the well casing PT. For example, the inlet well screen 24 can be located at or near the bottom end 22B of the straw 22, which can be up to hundreds of feet deep in the ground when the straw is installed in some embodiments. Further, the straw 22 can comprise second, or outlet, well screen 26 in a portion of the straw wall 28 that can be positioned inside the liner sleeve LS adjacent a portion of the backfill soil mixture SM. Thus, the inlet well screen 24 can be proximate to the bottom end 22B of the straw 22 and the outlet well screen 26 can be located between the top end 22A of the straw 22 and the inlet well screen 24. When installed, the inlet well screen 24 can be positioned in confined water-bearing strata under sufficient hydraulic pressure to force the groundwater up the straw 22 to the outlet well screen 26. In particular, the inlet well screen 24 and the outlet well screen 26 can comprise apertures 24A, 26A that extend through the straw wall 28 from the circumferential surface at straw perimeter diameter D_{OS} to the internal channel 32 to permit groundwater GW adjacent the inlet well screen 24 to enter into the internal channel 32 and travel up the internal channel 32 to exit the outlet well screen 26 through a pressure differential. For example, this movement of the groundwater GW can be accomplished by the groundwater GW adjacent to the inlet well screen 24 being under sufficient hydraulic head to move upward and out of a second, or outlet, well screen 26 located inside the liner sleeve LS so that the root system of the tree T can consume the groundwater and move the contaminants into parts of the remediation system 10B where they can be transformed, sequestered, or transpired. The outlet well screen 26 can be positioned at or near the bottom of the liner sleeve LS or the second bentonite layer BL₂ can be placed along the bottom of the liner sleeve LS. Generally speaking, the outlet well screen 26 should be positioned below the saturation line SL.

In some embodiments, the straw wall 28 can comprise different thicknesses to facilitate engagement of the cartridge 40. For example, as shown in FIGS. 3A and 3B, the straw wall 28 can comprise a first wall thickness 34 in a top portion 30A of the straw 22 and a bottom portion 30B of the straw 22 and a second wall thickness 36 in a middle portion 30C of the straw 22 where the outlet well screen 26 resides. The inlet well screen 24 can reside within the bottom portion 30B of the straw 22 having the first wall thickness 34. The second wall thickness 36 can be thicker than the first wall thickness 34 such that the straw has a first inner diameter D_{IS1} in the portions of the straw 22 with the first wall thickness 34 and a second inner diameter D_{IS2} in the portion of the straw with the second wall thickness 36. Thereby, the first inner diameter D_{IS1} of the straw 22 can be greater than the second inner diameter D_{IS2} of the straw 22. For example, in some embodiment, the top portion 30A of the straw 22 and the bottom portion 30B of the straw 22 can comprise 3-inch schedule 40 PVC while the middle portion 30C of the straw 22 can 3-inch schedule 80 PVC. The straw wall 28 can have a gradual transition segments 38 where the straw wall 28 transitions between the first wall thickness 34 and the second wall thickness 36. For example, the transition segments 38 can transition between the 3-inch schedule 40 PVC and the 3-inch schedule 80 PVC.

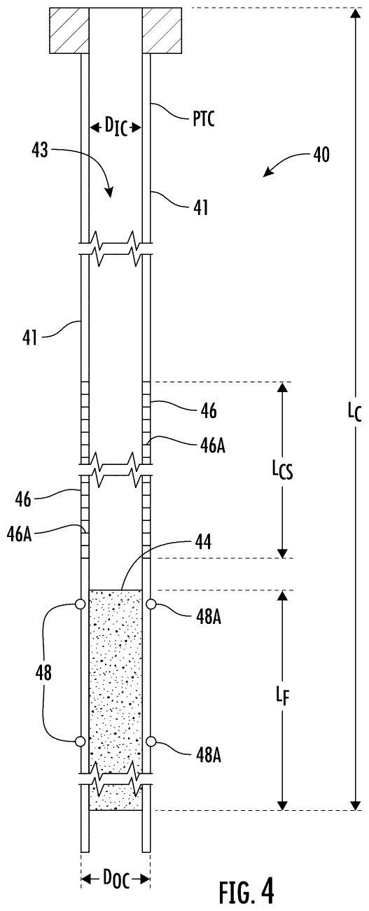

As stated above, the straw and cartridge apparatus 20 can also comprise a removable treatment cartridge 40 for insertion and removal from into the straw 22 as shown FIGS. 3A and 4. The treatment cartridge 40 having treatment media 42 within a filter section 44 of the treatment cartridge 40 with the filter section 44 configured to be positioned within the straw 22 between the outlet well screen 26 and the inlet well screen 24 of the straw 22 upon installation so that groundwater entering the inlet well screen 24 passes through the treatment media 42 of the filter section 44 of the cartridge 40 before exiting the outlet well screen 26 into the soil and/or soil mixture SM within the liner sleeve LS. The cartridge 40 can comprise a cylindrical well casing PTC that can have a cartridge perimeter diameter D_{oc} wherein the cartridge perimeter diameter D_{oc} is less than the second inner diameter D_{IS2} of the straw 22 such that the cartridge 40 fits inside the first and second inner diameters D_{IS1}, D_{IS2} of the straw 22. In some embodiments where the straw perimeter diameter D_{OS} of the straw 22 can be about 3 inches, the cartridge perimeter diameter D_{oc} of cylindrical well casing PTC of the cartridge 40 can be about 2 inches. For example, the cylindrical well casing PTC of the cartridge 40 can comprise a polyvinyl chloride (PVC) cylinder, such as a PVC pipe, which has a 2 inch outer diameter. The cylindrical well casing PTC of the cartridge 40 can comprise 2-inch schedule 40 PVC piping. The length L_{c} of the cartridge 40 can vary depending on the project in which the plant-remediation system 10B is being used and the position of the outlet well screen 26 of the straw 22.

Referring to FIGS. 3A and 4, the cylindrical well casing PTC of the cartridge 40 can be hollow such that an internal channel 43 can extend through the straw 22 between an interior surface of the straw wall 28. Thereby, the cartridge 40 can comprise an inner diameter D_{IC} in which the treatment media 42 within the filter section 44 of the treatment cartridge 40 is positioned and can be open on a bottom end for receiving the groundwater GW entering the straw 22. The groundwater entering and traveling up the straw 22 can flow into the open bottom end of the cartridge 40. The cartridge 40 can also comprise a cartridge well screen 46 that is positioned above the position of the treatment media 42 within the filter section 44 of the treatment cartridge 40 that can be aligned with the outlet well screen 26 of the straw 22 upon installation. The cartridge well screen 46 can comprise apertures 46A that extend through cylindrical well casing PTC of the cartridge 40 from a circumferential surface at cartridge perimeter diameter D_{oc} to the internal channel 43 of the cartridge 40. In this manner, groundwater GW can travel up the internal channel 32 of the straw 22 and enter the internal channel 43 of the cartridge 40. It can then pass through the treatment media 42 within the filter section 44 of the treatment cartridge 40 before exiting the cartridge 40 through the cartridge well screen 46 of the cartridge 40 and the outlet well screen 26 of the straw 22 into the soil and/or soil mixture SM within the liner sleeve LS. To further filter the groundwater exiting the outlet well screen 26 into the soil and/or soil mixture SM within the liner sleeve LS, the straw 22 can comprise a filter wrap 50 positioned around the outlet well screen 26 in some embodiments. In some embodiments, the filter wrap 50, for example, can comprise a fabric such as a nonwoven, woven, or knit fabric that is porous enough to allow groundwater to easily pass therethrough. In some embodiments, the filter wrap 50 can comprise an open cell foam.

Referring to FIGS. 3A and 4, to facilitate the movement of the groundwater GW through the cartridge 40 instead of around the cartridge 40, the cartridge 40 can further comprise a seal 48 positioned along the cartridge perimeter diameter D_{oc} at a perimeter circumferential surface of the cartridge 40. The seal 48 can be positioned within the second inner diameter D_{IS2} of the straw 22 upon installation to provide a tight seal to prevent groundwater within he straw 22 from seeping up between the cartridge 40 and the straw 22. In some embodiments, the seal 48 can comprise a first O-ring 48A and a second O-ring 48B spaced apart from each other and below the cartridge well screen 46 and the outlet well screen 26 of the straw 22 upon installation. The cartridge 40 can be setting grooves within the perimeter circumferential surface of the cartridge 40 in which the first O-ring 48A and the second O-ring 48B can reside such that the first O-ring 48A and the second O-ring 48B have a sealing contact with the internal channel 32 of the straw 22 to form the seal when the cartridge 40 is installed in the straw 22 that prevents the traveling of water upward in the annulus between the straw 22 and the cartridge 40.

The treatment media 42 can be a filtering substance that can removed contaminants from the groundwater GW. For example, the treatment media 42 can comprise a granular activated carbon or resin. The filter section 44 can have a length L_{F} of treatment media 42 within the treatment cartridge 40 that provides filtering of the groundwater GW to remove at least some of the contaminants within the groundwater GW before it enters the soil mixture SM within the liner sleeve LS. The length L_{F} of treatment media 42 can be dependent on the volume of treatment media required for filtering the groundwater GW and the frequency at which the cartridge 40 will be changed during the use of the vegetation-based remediation system 10B. Additionally, the outlet screen 26 of the straw 22 can have a length L_{OS} and the inlet screen 24 of the straw 22 can have a length L_{IS}. The length L_{OS} of the outlet screen 26 of the straw 22, which correspond to the length of the well screen 46 of the cartridge 40, and the length L_{IS} of the inlet screen 24 of the straw 22 can vary depending on the project in which the plant-remediation system 10B is being used. In some embodiments, the length L_{OS} of the outlet screen 26 of the straw 22 and the length of the well screen 46 of the cartridge 40 can be one (1) foot or greater. In some embodiments, the length Lᵢₛ of the inlet screen 24 can be one (1) foot or greater.

To facilitate the removal of a use cartridge 40 and insertion of a new cartridge 40, each of the treatment cartridge 40 can comprise a bracket 49 at a top end of the cartridge 40. The bracket 49 at a top end of the cartridge 40 can be configured to rest upon a top end of the straw 22 that resides above and outside of backfill of soil mixture SM. Thereby, the bracket 49 can provide an abutment to hold the cartridge 40 in position within the straw 22. Additionally, the bracket 49 can provide an element to hold for removal 22 and insertion of the cartridge 40 within the straw 22.

As stated above, the first and second bentonite layers BL₁, BL₂ form a barrier that prevents groundwater from beneath the liner sleeve LS entering into the back fill soil or soil mixture in the liner sleeve LS, for example, from around the straw and cartridge apparatus 20 that passes through the liner sleeve LS and first and second bentonite layers BL₁, BL₂. Installation of the plant-based remediation system can occur in a variety of ways. In some embodiments as shown in FIGS. 1-3B, once an area with contaminated soil or groundwater is identify for a vegetation-based remediation system 10B, a hole H at the desired location can be excavated and the first bentonite layer BL₁ and the liner sleeve LS can be installed. If needed or desired, a second bentonite layer BL₂ can be installed along the bottom of the liner sleeve LS. The liner sleeve LS can be backfilled with the soil mixture SM. A hole can be drilled through the soil mixture SM, liner sleeve LS, first and second bentonite layers BL₁, BL₂ and the native soil and/or bedrock NS to a depth of where the contaminated soil/groundwater resides. The straw and cartridge apparatus 20 can be installed in the hole so that the inlet well screen 24 of the straw 22 resides in the contaminated soil/groundwater and the outlet well screen 26 resides within the soil mixture SM in the liner sleeve LS, for example, close to the first and second bentonite layers BL₁, BL₂. Any space between the straw and cartridge apparatus 20 and the drilled hole can be filled with different materials to provide different functions. First, sand 14 can be added at the bottom around the inlet well screen 24 of the straw 22 to facilitate further filtering and to permit the passage of groundwater into the straw 22. Bentonite chips BL₃, such as ⅜ inch hole plug, 12A can be placed in the space between the straw and cartridge apparatus 20 and the drilled hole on top of the sand 14 and up to the first and second bentonite layers BL₁, BL₂ to provide a seal around the straw and cartridge apparatus 20 that helps to form an impermeable barrier 12 with first and second bentonite layers BL₁, BL₂. Soil or the soil mixture SM can be placed in the space between the straw and cartridge apparatus 20 and the drilled hole on top of the bentonite chips BL₃. The added soil or the soil mixture SM generally aligns with the soil mixture SM in the liner sleeve LS. A hole for the plant, such as tree T, can be excavated and the plant T with a root system can be planted in the hole in soil or the soil mixture SM in the liner sleeve LS.

As the vegetation-based remediation system 10B is used, the cartridges 40 can be exchanged as the treatment media 42 is used or becomes inactive. In particular, a used cartridge 40 installed in the straw 22 can be removed and a new cartridge 40 with fresh treatment media 42 therein can be installed. Spent treatment media 42 can be removed from the cartridge 40 and new media 42 can be added and the cartridge 40 can be reused. In this manner, the groundwater GW that is fed into the liner sleeve LS through the straw and cartridge apparatus 20 can be continually filtered before being fed into the soil mixture SM in the liner sleeve LS so that the root system of the tree T can consume the groundwater and move the remaining contaminants into parts of the remediation system 10B where they can be transformed, sequestered, or transpired. In this manner, the straw and cartridge apparatuses can enhance performance of the plant-based remediation systems as disclosed herein. The cartridges 40 can also allow the quantification of mass removal rates even in systems where active remediation is possible. An in-line cartridge 40 can be placed for a period of time after which it is removed, and the volume of contaminant mass is measured determining the rate of contaminant mass transfer into the remediation system 10B.

Thus, as disclosed herein, a vegetation-based remediation system can be provided that can comprise a liner sleeve for positioning within an excavated hole and a bottom impermeable barrier on which the liner sleeve resides. The bottom impermeable barrier can be positioned at a bottom of the excavated hole. The vegetation-based remediation system can comprise a backfill of soil mixture that is used to fill the liner sleeve once the liner sleeve is positioned within the excavated hole. The vegetation-based remediation system can comprise straw can be provided for insertion in a hole through the soil mixture, the liner sleeve, and the bottom impermeable barrier and into soil below the bottom impermeable barrier such that the straw extends below the bottom impermeable barrier upon installation upon installation. The straw can comprise an inlet well screen and an outlet well screen. The inlet well screen is positionable below the bottom impermeable barrier upon installation and the outlet well screen is positionable above the bottom impermeable barrier inside the liner sleeve adjacent a portion of the soil mixture upon installation of the straw. The vegetation-based remediation system can also comprise a treatment cartridge that is insertable into and removable from the straw. The treatment cartridge can comprise a filter section having treatment media therein. The filter section is configured to be positionable within the straw between the outlet well screen and the inlet well screen of the straw upon installation. Further, the vegetation-based remediation system can comprise a plant configured to be planted within the soil mixture in the liner sleeve.

In some embodiments of the vegetation-based remediation system, the straw can comprise a cylindrical well casing having a straw perimeter diameter. In some embodiments of the vegetation-based remediation system, the straw comprises a straw wall that forms a straw perimeter diameter. The straw wall can comprise a first wall thickness in a top portion of the straw and a bottom portion of the straw and a second wall thickness in a portion of the straw where the outlet well screen resides with the second wall thickness being thicker than the first wall thickness such that the straw has a first inner diameter in the portions of the straw with the first wall thickness and a second inner diameter in the portion of the straw with the second wall thickness such that the first inner diameter of the straw is greater than the second inner diameter of the straw.

In some embodiments of the vegetation-based remediation system, the treatment cartridge can comprise a cylindrical well casing having a cartridge perimeter diameter wherein the cartridge perimeter diameter is less than the straw perimeter diameter such that the treatment cartridge fits inside the first and second inner diameters of the straw. In some embodiments of the vegetation-based remediation system, the treatment cartridge can comprise an inner diameter in which the treatment media within the filter section of the treatment cartridge is positioned. In some embodiments of the vegetation-based remediation system, the treatment cartridge can comprise a cartridge well screen that is alignable with the outlet well screen of the straw upon installation. In some embodiments of the vegetation-based remediation system, the treatment cartridge further comprises a seal positioned along a perimeter circumferential surface of the treatment cartridge. In some embodiments of the vegetation-based remediation system, the seal comprises a first O-ring and a second O-ring spaced apart from each other and below the cartridge well screen of the treatment cartridge and the outlet well screen of the straw upon installation of the treatment cartridge in the straw. In some embodiments of the vegetation-based remediation system, the seal is positioned within the second inner diameter of the straw upon installation.

In some embodiments of the vegetation-based remediation system, a length of the treatment media within the treatment cartridge is dependent on a volume of treatment media required for filtering groundwater passing through the treatment media and a frequency at which the treatment cartridge will be changed.

In some embodiments of the vegetation-based remediation system, the treatment cartridge comprises a bracket at a top end of the treatment cartridge configured to rest upon a top end of the straw that resides above and outside of the soil mixture, the bracket providing an abutment to hold the treatment cartridge in place within the straw and provide an element to hold the treatment cartridge for removal and insertion of the treatment cartridge within the straw.

In some embodiments of the vegetation-based remediation system, the straw comprises a filter wrap positioned around the outlet well screen to further filter groundwater passing through the outlet well screen into the soil mixture within the liner sleeve.

In some embodiments of the vegetation-based remediation system, a second treatment cartridge for insertion into the straw upon removal of the treatment cartridge being removed due to the treatment media within the filter section of the treatment cartridge being spent, the second treatment cartridge comprising a filter section having treatment media therein.

Additionally, as disclosed herein, straw and cartridge apparatus configured for use within vegetation-based remediation system can be provided. The straw and cartridge apparatus can comprise a straw having a straw perimeter diameter and a length. The straw can comprise an inlet well screen that is positionable in soil below a bottom impermeable barrier of a vegetation-based remediation system and an outlet well screen that is positionable above the bottom impermeable barrier inside a liner sleeve of the vegetation-based remediation system upon installation of the straw in the vegetation-based remediation system. The straw and cartridge apparatus can also comprise a treatment cartridge insertable into the straw. The treatment cartridge can comprise a filter section having treatment media therein. The filter section is configured to be positionable within the straw between the outlet well screen and the inlet well screen of the straw when the treatment cartridge is installed into the straw so that groundwater entering the inlet well screen passes through the treatment media of the filter section of the treatment cartridge before exiting the outlet well screen within the liner sleeve.

In some embodiments of the straw and cartridge apparatus, the straw comprises a straw wall that forms a straw perimeter diameter. The straw wall can comprise a first wall thickness in a top portion of the straw and a bottom portion of the straw as well as a second wall thickness in a portion of the straw where the outlet well screen resides with the second wall thickness being thicker than the first wall thickness. In this manner, the straw has a first inner diameter in the portions of the straw with the first wall thickness and a second inner diameter in the portion of the straw with the second wall thickness with the first inner diameter of the straw being greater than the second inner diameter of the straw. In some embodiments of the straw and cartridge apparatus, the inlet well screen can be located proximate to a bottom end of the straw and the outlet well screen can be located between a top end of the straw and the inlet well screen. In some embodiments of the straw and cartridge apparatus, the treatment cartridge can comprise a cylindrical well casing having a cartridge perimeter diameter wherein the cartridge perimeter diameter is less than the straw perimeter diameter such that the treatment cartridge fits inside the first and second inner diameters of the straw. In some embodiments of the straw and cartridge apparatus, the treatment cartridge can comprise an inner diameter in which the treatment media within the filter section of the treatment cartridge is positioned. In some embodiments of the straw and cartridge apparatus, the treatment cartridge can comprise a cartridge well screen that is alignable with the outlet well screen of the straw upon installation. In some embodiments of the straw and cartridge apparatus, the treatment cartridge can further comprise a seal positioned along a perimeter circumferential surface of the treatment cartridge. In some embodiments of the straw and cartridge apparatus, the seal can comprise a first O-ring and a second O-ring spaced apart from each other and below the cartridge well screen of the treatment cartridge and the outlet well screen of the straw upon installation of the treatment cartridge in the straw. In some embodiments of the straw and cartridge apparatus, the seal can be positioned within the second inner diameter of the straw upon installation. In some embodiments of the straw and cartridge apparatus, a length of treatment media within the treatment cartridge can be dependent on a volume of treatment media required for filtering groundwater and a frequency at which the treatment cartridge will be changed. In some embodiments of the straw and cartridge apparatus, the treatment cartridge can comprise a bracket at a top end of the treatment cartridge configured to rest upon a top end of the straw that resides above and outside of a soil mixture in the liner sleeve in which the straw is installed. The bracket can provide an abutment to hold the treatment cartridge in place within the straw and provide an element to hold for removal and insertion of the treatment cartridge within the straw. In some embodiments of the straw and cartridge apparatus, straw can comprise a filter wrap positioned around the outlet well screen.

Further, as disclosed herein, a method of installing a vegetation-based remediation system for treating deep groundwater contamination can be provided, the method can comprise positioning a bottom impermeable barrier at a bottom of an excavated hole and inserting a liner sleeve within the excavated hole with a bottom of the liner sleeve residing on the bottom impermeable barrier. The method can comprise filling the liner sleeve with a soil mixture and planting a plant within the soil mixture in the liner sleeve. The method also comprises drilling a straw hole through the soil mixture in the liner sleeve, the liner sleeve, and the bottom impermeable barrier and into soil below the bottom impermeable barrier to a depth where contaminated groundwater resides. Additionally, the method can comprise inserting a straw comprising an inlet well screen and an outlet well screen in the straw hole such that the straw extends below the bottom impermeable barrier with the inlet well screen positioned in the soil below the bottom impermeable barrier upon installation and the outlet well screen positioned above the bottom impermeable barrier inside the liner sleeve adjacent a portion of the soil mixture. Further, the method can comprise inserting a treatment cartridge comprising a filter section having treatment media therein into the straw with the filter section positioned within the straw between the outlet well screen and the inlet well screen of the straw.

The treatment cartridge can comprise a bracket at a top end of the treatment cartridge. In such embodiments of the method of installing a vegetation-based remediation system, the method can comprise resting the bracket of the treatment cartridge upon a top end of the straw that resides above and outside of the soil mixture back fill to provide an abutment to hold the treatment cartridge in place within the straw and provide an element to hold for removal and insertion of the treatment cartridge within the straw. In some embodiments of the method of installing a vegetation-based remediation system, the method can comprise placing a filter wrap around the outlet well screen to further filter groundwater passing through the outlet well screen into the soil mixture within the liner sleeve. In some embodiments of the method of installing a vegetation-based remediation system, the method can comprise removing the treatment cartridge when the treatment media is spent and inserting a second treatment cartridge with fresh treatment media therein. In some embodiments of the method of installing a vegetation-based remediation system, the method can comprise removing the treatment media that is spent from the treatment cartridge and placing new treatment media within the treatment cartridge so that the treatment cartridge can be reused.

These and other modifications and variations to the present subject matter may be practiced by those of ordinary skill in the art, without departing from the spirit and scope of the present subject matter, which is more particularly set forth herein above and any appending claims. In addition, it should be understood the aspects of the various embodiments may be interchanged either in whole or in part. Furthermore, those of ordinary skill in the art will appreciate that the foregoing description is by way of example only and is not intended to limit the present subject matter.

1. A vegetation-based remediation system, the vegetation-based remediation system comprising:
a liner sleeve for positioning within an excavated hole;
a bottom impermeable barrier on which the liner sleeve resides, the bottom impermeable barrier being positioned at a bottom of the excavated hole;
a backfill of soil mixture that is used to fill the liner sleeve once the liner sleeve is positioned within the excavated hole;
a straw for insertion in a hole through the soil mixture, the liner sleeve, and the bottom impermeable barrier and into soil below the bottom impermeable barrier such that the straw extends below the bottom impermeable barrier upon installation upon installation, the straw comprising an inlet well screen and an outlet well screen, the inlet well screen positionable below the bottom impermeable barrier upon installation and the outlet well screen positionable above the bottom impermeable barrier inside the liner sleeve adjacent a portion of the soil mixture upon installation of the straw;
a treatment cartridge that is insertable into and removable from the straw, the treatment cartridge comprising a filter section having treatment media therein, the filter section configured to be positionable within the straw between the outlet well screen and the inlet well screen of the straw upon installation; and
a plant configured to be planted within the soil mixture in the liner sleeve.

2. The vegetation-based remediation system according to claim 1, wherein the straw comprises a cylindrical well casing having a straw perimeter diameter.

3. The vegetation-based remediation system according to claim 2, wherein the straw comprises a straw wall that forms a straw perimeter diameter, the straw wall comprising a first wall thickness in a top portion of the straw and a bottom portion of the straw and a second wall thickness in a portion of the straw where the outlet well screen resides with the second wall thickness being thicker than the first wall thickness such that the straw has a first inner diameter in the portions of the straw with the first wall thickness and a second inner diameter in the portion of the straw with the second wall thickness, the first inner diameter of the straw being greater than the second inner diameter of the straw.

4. The vegetation-based remediation system according to claim 3, wherein the treatment cartridge comprises a cylindrical well casing having a cartridge perimeter diameter wherein the cartridge perimeter diameter is less than the straw perimeter diameter such that the treatment cartridge fits inside the first and second inner diameters of the straw.

5. The vegetation-based remediation system according to claim 4, wherein the treatment cartridge comprises an inner diameter in which the treatment media within the filter section of the treatment cartridge is positioned.

6. The vegetation-based remediation system according to claim 4, wherein the treatment cartridge comprises a cartridge well screen that is alignable with the outlet well screen of the straw upon installation.

7. The vegetation-based remediation system according to claim 6, wherein the treatment cartridge further comprises a seal positioned along a perimeter circumferential surface of the treatment cartridge.

8. The vegetation-based remediation system according to claim 7, wherein the seal comprises a first O-ring and a second O-ring spaced apart from each other and below the cartridge well screen of the treatment cartridge and the outlet well screen of the straw upon installation of the treatment cartridge in the straw.

9. (canceled)

10. The vegetation-based remediation system according to claim 1, wherein a length of the treatment media within the treatment cartridge is dependent on a volume of treatment media required for filtering groundwater passing through the treatment media and a frequency at which the treatment cartridge will be changed.

11. The vegetation-based remediation system according to claim 1, wherein the treatment cartridge comprises a bracket at a top end of the treatment cartridge configured to rest upon a top end of the straw that resides above and outside of the soil mixture, the bracket providing an abutment to hold the treatment cartridge in place within the straw and provide an element to hold the treatment cartridge for removal and insertion of the treatment cartridge within the straw.

12. The vegetation-based remediation system according to claim 1, wherein the straw comprises a filter wrap positioned around the outlet well screen to further filter groundwater passing through the outlet well screen into the soil mixture within the liner sleeve.

13. The vegetation-based remediation system according to claim 1, further comprising a second treatment cartridge for insertion into the straw upon removal of the treatment cartridge being removed due to the treatment media within the filter section of the treatment cartridge being spent, the second treatment cartridge comprising a filter section having treatment media therein.

14. A straw and cartridge apparatus configured for use within vegetation-based remediation system, the straw and cartridge apparatus comprising:
a straw having a straw perimeter diameter and a length, the straw comprising an inlet well screen that is positionable in soil below a bottom impermeable barrier of a vegetation-based remediation system and an outlet well screen that is positionable above the bottom impermeable barrier inside a liner sleeve of the vegetation-based remediation system upon installation of the straw in the vegetation-based remediation system; and
a treatment cartridge insertable into the straw, the treatment cartridge comprising a filter section having treatment media therein, the filter section configured to be positionable within the straw between the outlet well screen and the inlet well screen of the straw when the treatment cartridge is installed into the straw so that groundwater entering the inlet well screen passes through the treatment media of the filter section of the treatment cartridge before exiting the outlet well screen within the liner sleeve.

15. The straw and cartridge apparatus according to claim 14, wherein the straw comprises a straw wall that forms a straw perimeter diameter, the straw wall comprising a first wall thickness in a top portion of the straw and a bottom portion of the straw and a second wall thickness in a portion of the straw where the outlet well screen resides with the second wall thickness being thicker than the first wall thickness such that the straw has a first inner diameter in the portions of the straw with the first wall thickness and a second inner diameter in the portion of the straw with the second wall thickness, the first inner diameter of the straw being greater than the second inner diameter of the straw.

16. The straw and cartridge apparatus according to claim 15, wherein the treatment cartridge comprises a cylindrical well casing having a cartridge perimeter diameter wherein the cartridge perimeter diameter is less than the straw perimeter diameter such that the treatment cartridge fits inside the first and second inner diameters of the straw.

17. (canceled)

18. The straw and cartridge apparatus according to claim 16, wherein the treatment cartridge comprises a cartridge well screen that is alignable with the outlet well screen of the straw upon installation.

19. (canceled)

20. The straw and cartridge apparatus according to claim 19, wherein the seal comprises a first O-ring and a second O-ring spaced apart from each other and below the cartridge well screen of the treatment cartridge and the outlet well screen of the straw upon installation of the treatment cartridge in the straw.

21. The straw and cartridge apparatus according to claim 20, wherein the seal is positioned within he second inner diameter of the straw upon installation.

22. The straw and cartridge apparatus according to claim 14, wherein a length of treatment media within the treatment cartridge is dependent on a volume of treatment media required for filtering groundwater and a frequency at which the treatment cartridge will be changed.

23-25. (canceled)

26. A method of using a vegetation-based remediation system for treating deep groundwater contamination, the method comprising:
positioning a bottom impermeable barrier at a bottom of an excavated hole;
inserting a liner sleeve within the excavated hole with a bottom of the liner sleeve residing on the bottom impermeable barrier;
filling the liner sleeve with a soil mixture;
planting a plant within the soil mixture in the liner sleeve;
drilling a straw hole through the soil mixture in the liner sleeve, the liner sleeve, and the bottom impermeable barrier and into soil below the bottom impermeable barrier to a depth where contaminated groundwater resides;
inserting a straw comprising an inlet well screen and an outlet well screen in the straw hole such that the straw extends below the bottom impermeable barrier with the inlet well screen positioned in the soil below the bottom impermeable barrier upon installation and the outlet well screen positioned above the bottom impermeable barrier inside the liner sleeve adjacent a portion of the soil mixture; and
inserting a treatment cartridge comprising a filter section having treatment media therein into the straw with the filter section positioned within the straw between the outlet well screen and the inlet well screen of the straw.

27-31. (canceled)
